(19) United States
(12) Patent Application Publication
(10) Pub. No.: US 2011/0258668 A1
(43) Pub. Date: Oct. 20, 2011

(54) Method and apparatus for interacting with media programming in real-time using a mobile telephone device

(76) Inventors: Sagal B.H. Musa, New York, NY (US); Jefferson Zead Lloyd, New York, NY (US)

(21) Appl. No.: 13/135,014

(22) Filed: Jun. 22, 2011

Related U.S. Application Data
(63) Continuation of application No. 12/455,080, filed on May 27, 2009.
(60) Provisional application No. 61/130,262, filed on May 28, 2008.

(51) Int. Cl. H04N 5/445

(52) U.S. Cl. 725/61

(57) ABSTRACT

A system and method for providing real-time interaction with a multimedia program being presented to a viewer having an interactive end-user communications device. The system and method includes an applet distribution program to provide an applet to the interactive end-user communications device, where the applet includes a timer, time stamps and at least one interactive graphical user interface (GUI). The applet distribution program is operable to synchronize activation of the applet with the multimedia program while being presented to the viewer, wherein the applet generates, at a first predetermined time, a first interactive graphical user interface (GUI) on the end-user communications device, the first GUI displaying at least two values associated with the multimedia program for real-time selection by the viewer. A response signal is received from the end-user communications device when a predetermined metric associated with correct selections of the at least two values by the viewer is satisfied.

### CROSS REFERENCE TO RELATED APPLICATION

This patent application is a continuation of U.S. application Ser. No. 12/455,080, filed May 27, 2009, which claims the benefit of U.S. Provisional Application Ser. No. 61/130,262, filed May 28, 2008, the contents of which are incorporated by reference herein in their entirety.

### FIELD OF THE INVENTION

The present invention relates generally to distribution of multimedia programs to viewers requesting such programs, and more specifically to providing interactive participation while viewers watch the requested multimedia programs.

### BACKGROUND OF THE INVENTION

Multimedia content providers distribute their content through distribution channels over various transmission mediums. For example, television broadcasting companies, cable companies, telephone companies, satellite TV providers, among other content distributors distribute (e.g., broadcast) their multimedia content via the airwaves, cable lines, telephone lines, by satellite, and over the interne, among other distribution channels and mediums. The recipients, i.e., content viewers, select a particular content provider based on availability, reliability of the services, price, among other factors that are deemed important to the consumer.

Regardless of which content distributor, service provider or transmission medium is used to deliver multimedia content to the viewer, it has been observed that many viewers have often desired the ability to interact in real time with various types of multimedia programming that is available for viewing. For example, multimedia programming such as game shows are often deemed as being desirable for audience/viewer participation, since the viewers would experience a different and enhanced form of entertainment by not only being spectators, but by becoming active participants. Accordingly, many content providers and program producers have attempted to enable viewer participation with various forms of technology, such as with the use of the viewer's cell phone or other mobile device.

The cell phone has become a ubiquitous electronic device for audible communications and text messaging. As the cell phone or other mobile device is readily accessible for the user, it would seemingly be advantageous if a person could use their cell phone or mobile device as an electronic communications device for interacting or participating with multimedia content being broadcasted to television viewers or streamed by content providers from a website over the internet. Although desirable, a user of the cell phone or other wireless mobile device will unfortunately experience a delay when trying to use their cell phone, for example, to make a phone call or send a text message to interact and participate in real-time with a multimedia program being currently viewed by the user. If, for example, the format for participating in a game show was to dial a dedicated phone number, the viewers illustratively watching a game show on their television would find it quite impractical, as the number of phone lines is limited and the participating viewers would more often than not receive a busy signal. Therefore, real-time participation with the multimedia programming is limited when trying to interact by using telephone lines.

Alternatively, if the format for participating in a game show was to send a text message to content provider or service provider, the user would also find this technique to be impractical due to similar latency issues. Text messaging, or texting is the common term for the sending of “short” (originally 160 characters or fewer, including spaces) text messages from mobile phones using the Short Message Service (SMS). Short Message Service (SMS) is a communication service standardized in the GSM mobile communication system, using standardized communications protocols allowing the interchange of short text messages between mobile telephone devices. It is available on most digital mobile phones and some personal digital assistants with on-board wireless telecommunications. The individual messages which are sent are called text messages or, more colloquially, texts or SMS even when a different protocol is being used. The most common application of the service is person-to-person messaging, but text messages are also often used to interact with automated systems, such as ordering products and services for mobile phones, or participating in non-real-time contests.

Although text messaging has been a convenient and inexpensive form of communications, as noted above, latency issues have been problematic for the user when trying to receive multimedia information from the content provider and subsequently respond, i.e., interact, in real time to such multimedia programming. That is, when the user utilizes his/her cell phone with it's current texting (SMS) abilities in a setting (e.g., viewing a game show, shopping network and the like) that requires an instantaneous texting (SMS) occurrence with zero latency, such user would immediately realize that a real-time or instantaneous interactive experience with the broadcasted multimedia content is virtually impossible to achieve.

### SUMMARY OF THE INVENTION

The disadvantages heretofore associated with the prior art are overcome by the present invention of a novel and improved method and system that allows viewers of prerecorded multimedia programs, such as televisions shows, webcast programs and other broadcasted or webcasted multimedia content to interact in real time with such prerecorded programs via a mobile device, such as a cell phone and cell phone platforms when watching the television and Internet content (i.e., series, shows and the like).

As noted above, if an individual were to utilize the cell phone with its texting abilities in a setting that requires an instantaneous texting occurrence with zero latency, such individual would quickly realize that with the current level of technology, such instantaneity is virtually impossible to achieve. One aspect of the present invention is the structuring of a technological protocol that enables one or more individuals to utilize their cell phones and its texting abilities in situations where a zero-latency prerequisite is required. This zero-latency texting ability is achieved through what is referred to as “A Time-Stamped Module” or applet.

The present invention includes downloading and storing a programmed applet/application to the cell phone. This applet contains programming code that achieves at least the following features: (i) interacts intelligently with the native environment of the particular phone, and (ii) presents the cell phone user with an interface e.g., GUI or pop-up window on the display that is structured for the particular application which requires such instantaneous interaction from the cell phone user.

The applet helps to facilitate the instantaneous experience by the viewer by operating on a Time-Stamped Protocol, whereby this applet interface is synchronized to activate and generate particular graphics on the display screen of the cell phone at predetermined times and provide the cell phone user with any necessary instructions/answer palettes/interactive menus and the like that are utilized at those pre-programmed times. The time-Stamp feature of the applet of the present invention enables simulation of an instantaneous texting ability that is made available to the user and which is devoid of the waiting process (i.e., latency issues) that a normal texting protocol entails.

In a preferred embodiment, the present invention can be used for large-scale viewing of entertainment productions, primarily involving television and social networking Internet portals (but also including all other multi-platform combinations of TV-Internet-mobile). The cell phone users are able to participate with these entertainment packages (e.g., answer selections/ contestant selections, etc) in real-time. Alternatively, the present invention can be used to interact with on-demand prerecorded programming that is point-casted to the viewer's television set or other computer device having a display.

In one embodiment, the applet presents a sequence of graphical user interfaces (GUIs) having a choice of answers to questions being presented with the video content being presented to the viewer. Each GUI is based on templates that are downloaded and appear, for example, 24 hours before show time and they will run independent of the communication with the server. The system is capable of providing the multimedia content with associated predetermined questions included therein at predetermined times to millions of users during the course of the program. The applet generates the answer GUIs contemporaneously with the questions as they are presented to the viewer. Further, since the questions and answers are known prior to being transmitted and presented to the viewers, the applet is able to quickly determine the number of correct answer responses and send indicia of each winning participant back to the server of the service provider.

For example, multiple choice type questions can be displayed to registered users while viewing an entertainment program, such as a game show over the Internet (e.g., MySpace, YouTube, Facebook and the like) or the television (e.g., NBC, CBS, ABC, cable programs, and the like). The multiple choice answers can be presented on the display of the cell phone by the applet. Alternately, the answers can be presented by the applet on the display screen of the user's television or computer device. The user interacts (i.e., participates in the game) with the GUI by selecting an appropriate numbered key on the key pad of the cell phone which corresponds to one of the answer choices shown on the display. After a series of questions are answered, the applet computes and presents an overall score to the user. In one embodiment, if the correct number of answers equals a predetermined number of correct answers, the score is transmitted to the server of the game-show host (e.g., carrier, service provider or content provider) while viewing the game on the Internet/TV. In one embodiment, winners of the game are determined randomly based highest scores. Alternatively, any number of winners can be eligible for a promotional type reward, such as a coupon, gift certificate and the like.

### BRIEF DESCRIPTION OF THE DRAWINGS

Further advantages and features of the present invention will become apparent from the detailed description of a preferred embodiment of the invention with reference to the accompanying drawings, in which:

FIG. 1 is a block diagram of a communications system suitable for implementing the present invention;

FIG. 2 is flow diagram of a method for providing an applet to an end-user's communications device to provide real-time interaction with multimedia programming being presented to the user;

FIGS. 3A-3B collectively depict a flow diagram of a method of operating the end-user's communications device with the applet, in accordance with the method of FIG. 2.

FIG. 4 is graphical representation of a first embodiment of the end-user communications device having a display panel illustratively presenting a reminder message in accordance with the method of FIGS. 3A and 3B;

FIG. 5 is a graphical representation of the end-user communications device of FIG. 4 having a display panel illustratively presenting a graphical user interface for participating in real time with multimedia programming being viewed by a viewer in accordance with the method of FIGS. 3A and 3B;

FIG. 6 is a graphical representation of a second embodiment of the end-user communications device illustratively presenting selected multimedia programming and corresponding graphics to enable real time user participation with the multimedia programming in accordance with the method of FIGS. 3A and 3B; and

FIG. 7 is a block diagram of an illustrative computer device suitable for implementing the present invention in the system of FIG. 1.

To facilitate understanding of the invention, identical reference numerals have been used, when appropriate, to designate the same or similar elements that are common to the figures. Further, unless stated otherwise, the drawings shown and discussed in the figures are not drawn to scale, but are shown for illustrative purposes only.

### DESCRIPTION OF THE PREFERRED EMBODIMENTS

The present invention relates to a method and system for interacting with multimedia programming in real-time using an end-user communications device. In particular, the present invention enables a viewer to select and watch specific pre-recorded multimedia programming, such as television shows or internet programs on their television or other display device, and subsequently participate with the viewed programming by responding in real time to questions being contemporaneously displayed with the selected programming using an end-user communication device, such as a cellular telephone or other mobile communication device. The multimedia content includes prerecorded or filmed questions, and the cellular telephone includes a previously downloaded applet that is synchronized to execute and operate contemporaneously with the multimedia content questions being presented to the viewer. The applet can generate and display on the display screen of the communication device, a graphical user interface (GUI) or pallet having two or more answers to the question currently being displayed with the video content on the television.

The applet in accordance with the present invention is preloaded and stored in the memory of the viewer's end-user communication device. The applet is activated at a predetermined time and is synchronized with the prerecorded multimedia content being presented to the viewer. In one embodiment, as the user watches the program (e.g., game show, shopping network, or other prerecorded multimedia content, questions are presented to the viewer at predetermined time intervals. At each interval, the applet contemporaneously generates a GUI on the viewer's end-user communication device, which displays one or more choice of answers on the display screen.

Synchronization between the multimedia program and the activation of the applet in real time is facilitated by a service provider or other content provider that has access to review the prerecorded program prior to it being broadcasted. Accordingly, the questions and corresponding answers are generated prior to the program being transmitted (e.g., broadcasted) to the general public or otherwise made publicly available during the scheduled time slot for a particular day. For example, a set questions and a corresponding set of answers can be generated for a prerecorded shopping network program, a game show or any other prerecorded program for presentation to the viewers at predetermined intervals during the course of the program. At the predetermined intervals, the viewer is presented with a question and a selection of answer choices from which he/she can choose, with one of the choices being the correct answer and the remaining choices being incorrect answers to the currently presented question. The questions and answers can be in the form of multiple choice questions, true/false questions, and the like. The viewer answers the question by pressing a designated key on the keypad, which causes the applet to store the answer.

In order to reduce the latency effect from text messaging and provide a real-time experience for the viewers using mobile devices such as cellular telephones or other devices that provide text messages, the applet for generating the answers is preloaded on the viewers end-user's communication device. The applet, once loaded on the end-user communications device, is activated by a transmitted signal (e.g., SMS text message) from the service provider which causes the applet to execute and initiate one or more internal timers that trigger the applet to subsequently display the GUI showing either a program reminder message or the answers to questions that are currently appearing on the multimedia program being viewed by the end-user viewer. The user is allocated a predetermined time to submit an answer to the questions and once the question is answered or the predetermined time has lapsed, the current GUI displaying the answers to the question is terminated, and the cellular device resumes displaying the underlying content that was previously being displayed.

As the timer of the applet continues to count, it remains synchronized with the prerecorded program. The synchronization continues even while commercial advertisements are presented at predetermined times with the selected program. Once the last set of questions has been answered by the viewer, the applet determines a total number of correct answers selected by the viewer during the course of the program. If the total number of correct choices exceeds a predetermined metric, such as a percentage, either the raw score or the percentage of correct answers is sent to the service provider. Otherwise, no information is sent to the service provider. The service provider can then use the score to declare one or more winners, which can then be eligible for marketing promotions (e.g., gift certificates, prizes, among other promotions). The applet enables the viewer to participate in real time with a selected program without the previously experienced latency issues that have occurred with text messaging using a cellular device. In this manner, such interactivity can be useful for promoting broader viewership of the content, which can also be beneficial for program ratings and commercial advertisers that advertise during the course of the programming.

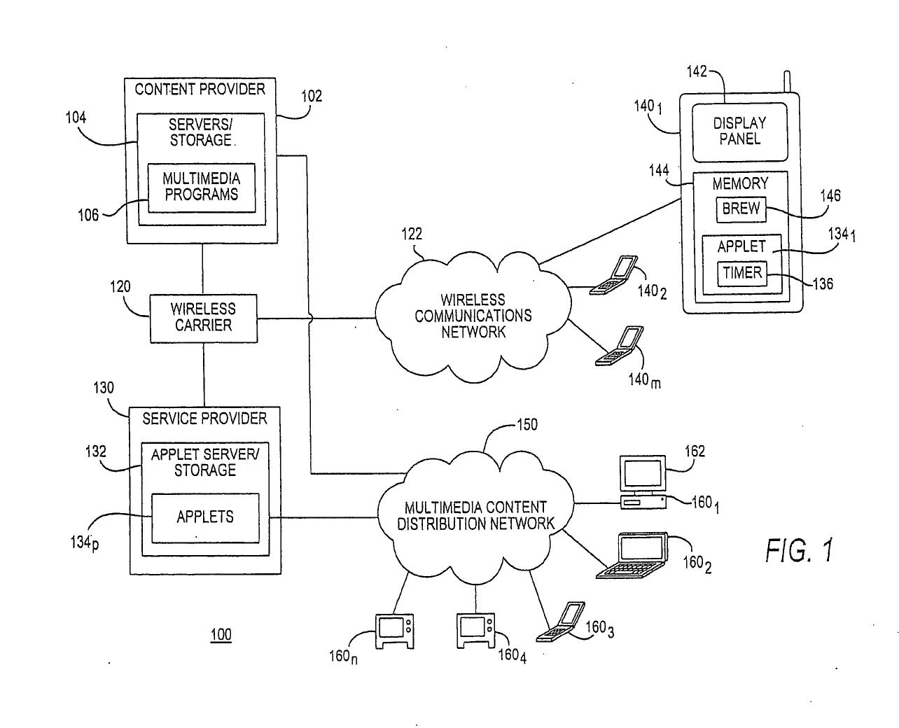

As will be described in detail below, one embodiment of the present invention can be implemented as a program product for use with computer devices in a multimedia communications system such as, for example, the system 100 shown in FIG. 1. The program(s) of the program product defines functions of the preferred embodiment and can be contained on a variety of signal/bearing media, which include, but are not limited to, (i) information permanently stored on non-writable storage media, (e.g., read-only memory devices within a computer such as CD-ROM disks readable by a CD-ROM drive); (ii) alterable information stored on writable storage media (e.g., floppy disks within a diskette drive, hard-disk drive or flash memory); or (iii) information conveyed to a computer by a communications medium, such as through a computer or telephone network, including wireless communications. Such signal-bearing media, when carrying computer-readable instructions that direct the functions of the present invention, represent embodiments of the present invention.

Referring now to FIG. 1, a multimedia communications system 100 for facilitating the present invention is illustratively shown. The multimedia communications system 100 comprises a content provider 102 that provides multimedia programs 106 to a plurality of viewer display devices 160₁ through 160ₙ (collectively viewer display devices 160) each having electronic circuitry for receiving the multimedia programs 106 via a multimedia content distribution network 150 in a well known manner. The content provider 102 can be an entity such as a television broadcast company, an internet content provider, a cable company, a telephone company, or any other content provider that has, for example, one or more servers and storage devices 104 for storing and transmitting the pre-recorded multimedia programs 106 to the viewer display devices 160 upon request by a viewer in a well-known manner.

For example, where the content provider 102 is a television broadcast company, the multimedia content distribution network 150 can include digital content that is broadcasted over the airwaves. Alternatively, where the content provider 102 is a cable company, the multimedia content distribution network 150 can be a coaxial or fiber optic cabling system that delivers the multimedia programs 106 to the viewer display devices 160. Similarly, where the content provider 102 is an internet content provider, then the multimedia content provider 150 distributes the content over a public/private packetized network such as the internet.

A multimedia program 106 includes any pre-recorded multimedia content, such as movies, television shows, game shows, music events, talk shows, sporting events or any other pre-recorded multimedia programming that can be distributed to and accessed for free or by subscription by viewers of such programs. In a preferred embodiment, the multimedia programs 106 include game shows, shopping network shows and the like, in which the viewer can participate with such programs in real-time by downloading a specific application program or applet 134 of the present invention from a service provider 130 or content provider 102 to either the viewer's display device 160 or other communications device, such as a mobile communications device 140₁ through 140ₘ (collectively “mobile communication devices” 140) such as cellular telephone. For purposes of understanding the invention, the mobile communications devices will be referred to as cellular telephones, and the viewer display will refer to television sets, laptops, desktops and other computer devices that include a display and are capable of tuning and/or receiving multimedia programs that are broadcasted or sent as packetized information upon request by a viewer.

The pre-programmed multimedia programs 106 can include talk shows, game shows, soap operas, movies or any other prerecorded content that is available either by local or national broadcasting techniques or by subscription order to viewers during specific time slots of the day. The pre-programmed multimedia programs 106 can also include prerecorded on-demand programs that are available, for example, by subscription, and which allow the viewers to access and view the prerecorded program at any time during the day. In one embodiment, a particular multimedia program 106 can include a sequence questions that are filed or otherwise overlay the primary video content at predetermined times. For example, a game show program can have a sequence of questions that are prerecorded as the game show is performed and taped. Alternatively, the game show can be prerecorded and the sequence of questions can be inserted into a number of frames of the game show at predefined intervals during the course of the program.

The service provider 130 includes an applet server and storage 132 for storing and distributing the applets 134 to the viewer display devices 160 and/or the cellular devices 140, as required. Although the applets 134 are illustratively shown as being provided by a service provider 130, a person of ordinary skill in the art will appreciate that the applets 134 can also be provided to the end user communication devices 140, 160 by the content provider 102.

Recall that, previously, viewers could view the pre-recorded multimedia programs 106 with limited ability to interact with such programs with their cellular devices 140 due to latency issues. These latency issuers were caused by delays in sending text messages via the cellular device 140. The present invention enables viewers to use their mobile cellular devices 140 to interact with the multimedia programs 106 without the noted latency issues described above. In fact, all the user need do is register with the service provider 130 to download an applet 134 which is programmed specific for the communications device 140, 160 that the viewer is using, and the applet 134 enables the viewer to interact with a multimedia program as it is being broadcasted or otherwise transmitted to the viewer.

The viewers can register and receive the downloaded applet after they sign up via the official website/social network carrying the interactive content. In another embodiment, the applet download is sent after the viewers register via a text-message (SMS) to the wireless provider carrying the content. In yet another embodiment, the applet download is sent to the viewers after they have subscribed to the applet/content plan via the wireless provider carrying the content.

Although the applets 134 are generally described as being transmitted to the cellular devices 140 to enable viewer interaction while watching a program on a secondary viewer display device 160 such as a television set, laptop and the like, the applets 134 can alternatively be transmitted to a viewer communication device such as a laptop, desktop or other computer device itself. In this manner, each viewer can choose from various types of communication devices to participate with the multimedia programming.

For example, if an individual wishes to watch a pre-recorded multimedia program such as a game show on their laptop computer, the viewer will register with the service provider 130 from their laptop computer. The applet server 132 will transmit an applet 134 that is specific for the brand and model number of the laptop computer that the viewer registered via the multimedia content distribution network 150. Accordingly, the laptop computer is used by the viewer to view the pre-recorded multimedia program that he or she has selected, and the downloaded applet 134 will activate at predetermined times and provide a GUI on its display to enable the viewer to interact with the multimedia programming in a real-time manner.

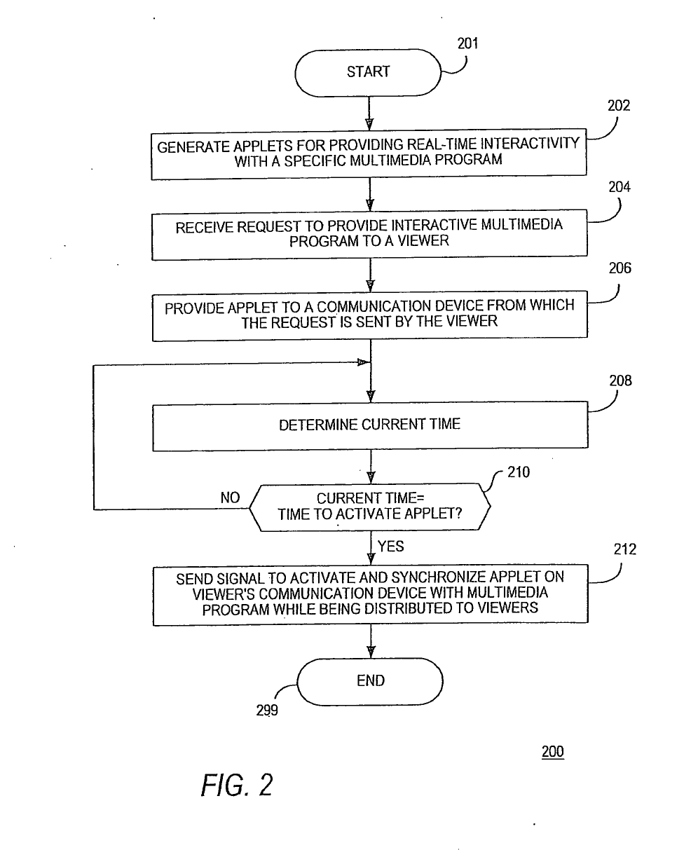

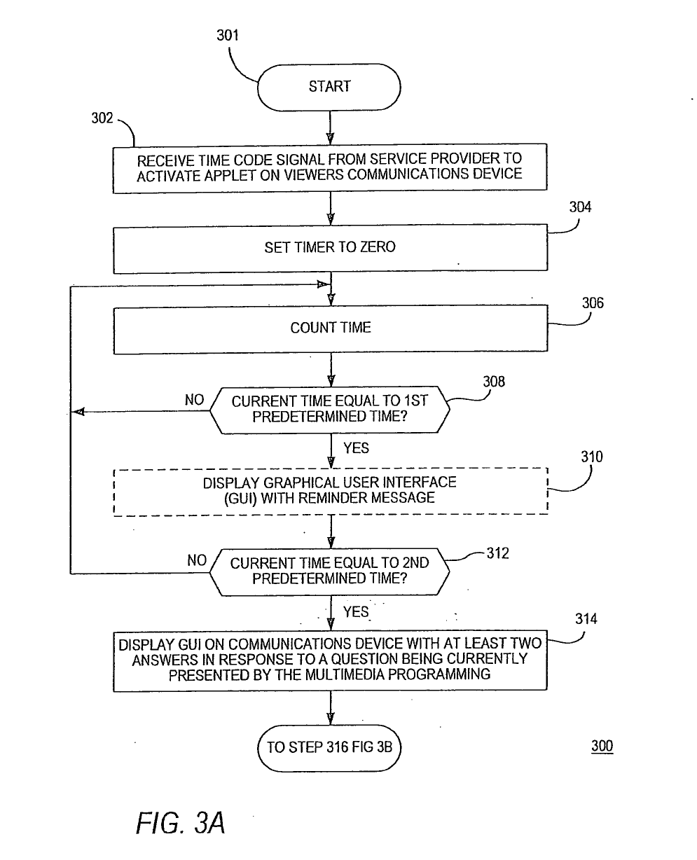

Alternatively, if the end-user wishes to watch the pre-recorded multimedia program on his or her television set and use their mobile cellular telephone 140 as a device for interacting with the multimedia program 106, the viewer will register for the multimedia using their mobile cellular device 140 by sending a test message to the wireless carrier 120 via the wireless communications network 122. The wireless carrier can be any well know provider of wireless services, such as VERIZON, AT&T, SPRINT, and the like. The service provider 130 will transmit the applet 134 that is specific for the brand and model of the mobile cellular telephone 140 to the wireless carrier 120, which will forward the applet 134 to the cellular telephone via the wireless communications network 122. At the designated time slot (or immediately after the request is made if the program is an on-demand program), the content provider 102 provides the multimedia program 106 to the television set of the viewer in a well-known manner over the multimedia content distribution network 150, such as by broadcasting it over the airways or by transmitting the content over cable systems, among other well-known distribution methods. At a predetermined time which is synchronized with the multimedia program, the applet 134 that was preloaded on the cellular telephone 140 will activate to enable the viewer to use the cellular device 140 to participate (i.e., interact) with the requested multimedia program being shown on the television set. Both of these embodiments are discussed in further detail with respect to the methods of FIGS. 2 and 3.

Accordingly, the communications system 100 of the present invention enables multiple viewers to view prerecorded programs contemporaneously (or at different times if on-demand programming) using any brand or model communication device, such as a cellular telephone or other computer device to interact and participate with the content (e.g., questions) being presented to the viewer in real time. The viewer's ability to interact with the programming in real time results from the activation of the applets in the viewer's communication device (e.g., cell phone 140) being synchronized with the multimedia program being provided by the content provider 102.

Although the servers and computer devices are depicted in FIG. 1 as general-purpose computers that are programmed to perform various control functions in accordance with the present invention, the invention can be implemented in hardware such as, for example, an application specific integrated circuit (ASIC). As such, it is intended that the processes described herein be broadly interpreted as being equivalently performed by software, hardware, or a combination thereof Accordingly, the servers and computer devices operate as special purpose controllers when executing programs for distributing and executing the applets of the present invention.

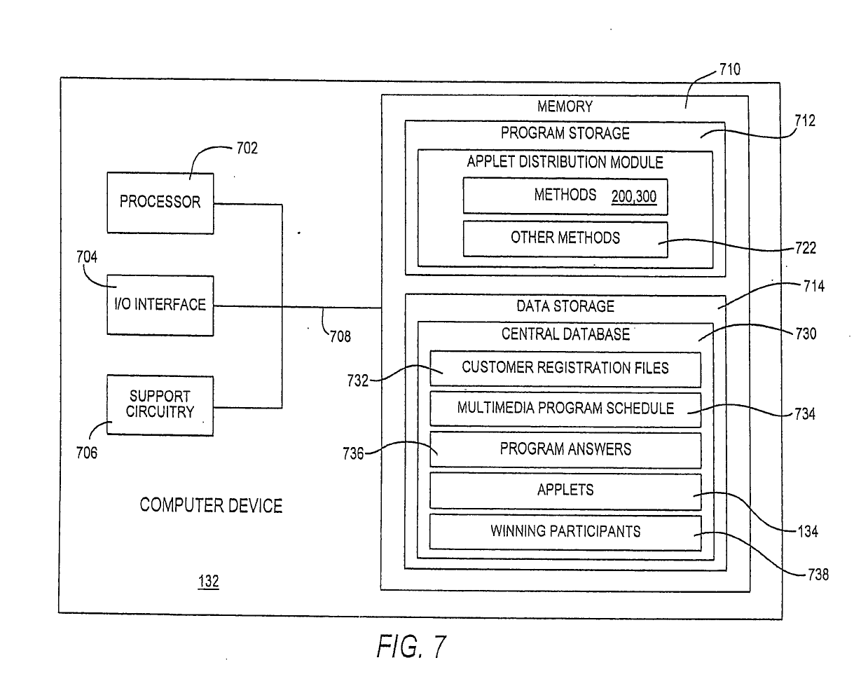

Referring to FIGS. 1 and 7, it is noted that the servers and computer devices 104, 132, 140, 160 include at least one processor or microprocessor 702, as well as memory 710 for storing various control programs. The processor 702 may be any conventional processor, such as one or more Intel Processors. The memory 710 may comprise volatile memory (e.g., RAM), non-volatile memory (e.g., disk drives) and/or a combination thereof. As shown in FIG. 7, the memory 710 illustratively includes program storage 712, which can include an operating system (not shown) and an applet distribution module for executing methods 200, 300 and other methods 722, as required. Data storage 714 can be an array of disk drives which include a central data base 730 having records or files associated with customer registration files 732, multimedia program schedules, program question/answer files or records 736, and a plurality of applets 134. The plurality of applets 134 can include programming or coding to enable operation on various types of end-user communications devices 140, 160, based on the brand and model thereof. In particular, different brand and models of end-user communications device may require specific programming to execute and display the GUIs 402, 502 and 606 on its display panel.

The processor 702 cooperates with conventional support circuitry 706, such as power supplies, clock circuits, cache memory and the like, as well as circuits that assist in executing the software routines stored in the memory 710. As such, it is contemplated that some of the process steps discussed herein as software processes may be implemented within hardware, for example, as circuitry that cooperates with the processor to perform various steps. The above-mentioned servers/computer devices also contain input/output (I/O) circuitry 706 that forms an interface between the various functional elements communicating with the servers/computer devices. For example, transmission lines and/or cabling is provided for transferring the multimedia content and applets as between the content provider 102, the wireless carrier 120, the service provider 130 and the various end-user communications devices 140 and 160. The processor 702, I/O interfaces 704, memory 710 and support circuitry 706 communicate with each other via one or more bus lines 708 in a well known manner.

Although FIG. 1 illustratively depicts a single server 104, 132 at the content provider 102 and service provider 130, a person of ordinary skill in the art will appreciate that a plurality of servers or server farms can be used to distribute the multimedia programs and the applets of the present invention. In one embodiment, a first group of servers can be dedicated for downloading the applet (with its graphics, imbedded advertising, etc) to the cell phones, a second group of servers can be dedicated for the programs specific detail contents such as timers and answers, to the cell phones. Other variations and combinations of servers can be implemented to provide the applet and particular game information to the cell phones based on the engine, templates, processing, bandwidth and other server constraints. Further, one or more servers can be implemented for sending reminder messages and receiving the computed scores to the answers from the cell phones.

Referring to FIG. 2, a flow diagram of a method 200 for providing applets to end-user communication devices to interact with a requested prerecorded multimedia program in real time is illustratively shown. The method starts at step 201, where the content provider 102, wireless carrier 120 and/or service provider 130 reviews selected prerecorded multimedia programs and generates questions and answers pertaining to the programs, which will be presented to the viewing audience at various intervals during the course of the program. The questions/answers can be multiple choice questions, true/false questions or any other questions deemed suitable for presentation with a multimedia program. For example, the questions can be associated with marketing promotions, demographics, gender, among other types of questions.

The questions are integrated with the multimedia programs 106. Preferably, the questions can be presented as part of the programs as they are recorded. Alternatively, the questions are inserted or otherwise overlie the program content after the program is recorded, but prior to distribution to the public by broadcast, pointcast, streaming or otherwise distributed to the viewers.

The answers to the questions can be stored as records or files 736 for each program in the central database 730 of the data storage memory 714, although such memory location is not limiting. As described above, each program can have a series of questions that are presented at predetermined times during the course of the program. The questions can be inserted, for example, at the bottom of a group of frames overlaying the video content that will be displayed. Alternatively, the questions can be presented in a pop-up window or in any other well known presentation format.

In one embodiment, the service provider 130 stores multimedia program schedules 734 in the central database 730. The multimedia program schedules 734 can include the time stamp information for each program which is associated with the time intervals the questions are to be presented to the viewer by the content provider. In one embodiment, the applet distribution module 720 accesses the multimedia program schedule 734 to retrieve the time stamp information for a requested program for insertion into the appropriate applets for subsequent transmission to the end-user communication devices 140, 160. Alternatively, the applets are pre-coded with the time stamp information and the multimedia program schedule 734. In either embodiment, the multimedia program schedule 734 can also be accessed to determine a time that the program specific applets 134 are transmitted or otherwise delivered to the end-user communication devices 140, 160.

More specifically, the questions are presented to the viewer at a predetermined time for a predetermined duration. The frames of the prerecorded multimedia program, and accordingly, those frames having the overlaid or prerecorded questions are time stamped, thereby establishing a known time when the questions will be appear on the display of the viewer's television or computer device during presentation of the requested program. Once the applets 134 are activated on the end-user's communication device 140, 160, the time stamp codes programmed into the applets enable the applets 134 to be synchronized with frames of the multimedia program during presentation to the viewers.

At step 202, the service provider 130 generates and stores various versions of applets 134 for providing real-time interactivity with a specific multimedia program. The applets can be stored in the data storage 714 of memory 710 of the applet server 132, although such memory location is not limiting. The different versions of applets 134 are programmed to operate on specific brands and models of viewer communication devices such as cell phones and other wireless devices, laptop computers, or any other communication devices capable of storing and executing the applet at predetermined times.

In one embodiment, the central database730 can include end-user communication device records or files (not shown) containing specification information for various types of communication devices. The information can include information such as type, brand, model, operating system data, display graphics data, driver data, and the like to enable the applet to properly and timely execute and operate on the end-user communication device used to request the applet. The applet distribution module 720 can retrieve the necessary data from end-user communication device records to include the proper coding in the applets. Alternatively, the applets can be pre-coded with the necessary end-user communication device specs.

The applets include the necessary programming that generates specific graphics that the user can respond to in order to interact with and transmit a response signals back to the service provider in a real-time manner. This real-time interactivity is effectuated by transmitting the applet 134 to the end-user's device such as a cellular device 140 or computer device (e.g., laptop) prior to the prerecorded program 106 being presented to the viewer. Each applet is program specific and is synchronized with the program content to operate at predetermined times, thereby allowing the user to respond without delays with respect to the content being presented to the viewer on their display device 160.

At step 204, the applet distribution module 720 of the service provider 130 receives a request to provide interactive multimedia program to a viewer. Referring to FIG. 1, the request can be sent via a mobile communications device such as a cellular telephone 140 over a wireless communications network 122 or the viewer can send the request from another type of communications device 160, such as their desktop or their laptop computer via a multimedia content distribution network 150 such as the internet to the service provider 130. In one embodiment, the request is in the form of a registration request. Registration information regarding a customer or subscriber identifier, as well as information regarding the brand and model from which the registration request originated can be stored as customer registration files 732 in the central database 730 of the service provider 130. The registration information can be permanently saved or deleted after the program ends, based on marketing requirements and/or viewer privacy issues.

At step 206, the applet distribution module 130 registers the viewer as a subscriber for the interactive multimedia program service by authenticating and authorizing the viewer requests. Once a subscriber for service is registered, the applet distribution module 720 transmits or otherwise provides the specific applet corresponding to the communications device from which the request was sent by the viewer to the communications device. For example, if viewer uses a cellular device 140 to make the request for a program, then the applet corresponding to the brand and model of the cellular device 140 is transmitted from the service provider 130 to the wireless carrier 120, which sends the applet 134 to the cellular device 140 via the wireless communications network 122 in a well known manner. Alternatively, if viewer uses a desktop computer 160 to make the request, then the applet corresponding to the brand and model of the computer device 160 is transmitted from the service provider 130 to the computer device 160 via the Internet as packetized information in a well known manner. Although the present invention is described as the service provider 130 receiving the request and distributing the applets to the viewers, one skilled in the art will appreciate that the content provider 102 (e.g., a cable/TV/network operator or internet content provider) or the wireless carrier 120 can provide such services to facilitate the interactive multimedia programming in accordance with the principles of the present invention.

At step 208, the applet distribution module 720 or other time server at the service provider determines the current time. Preferably, the current time is maintained by a time server which reads the actual time from a reference clock and distributes this information to its clients using a computer network. The time server may be a local network time server or an internet time server. The protocol for distributing and synchronizing time is preferably the Network Time Protocol (NTP) although other time protocols can be used as well. In particular, the Network Time Protocol is a protocol for synchronizing the clocks of computer systems over packet switch variable latency data network. Prior to the pre-recorded multimedia program being distributed over the communication networks to the viewers for presentation, the applets 134 for the specific end-user's communication devices are transmitted to the end user communication devices 140, 160 and is stored in its memory 144.

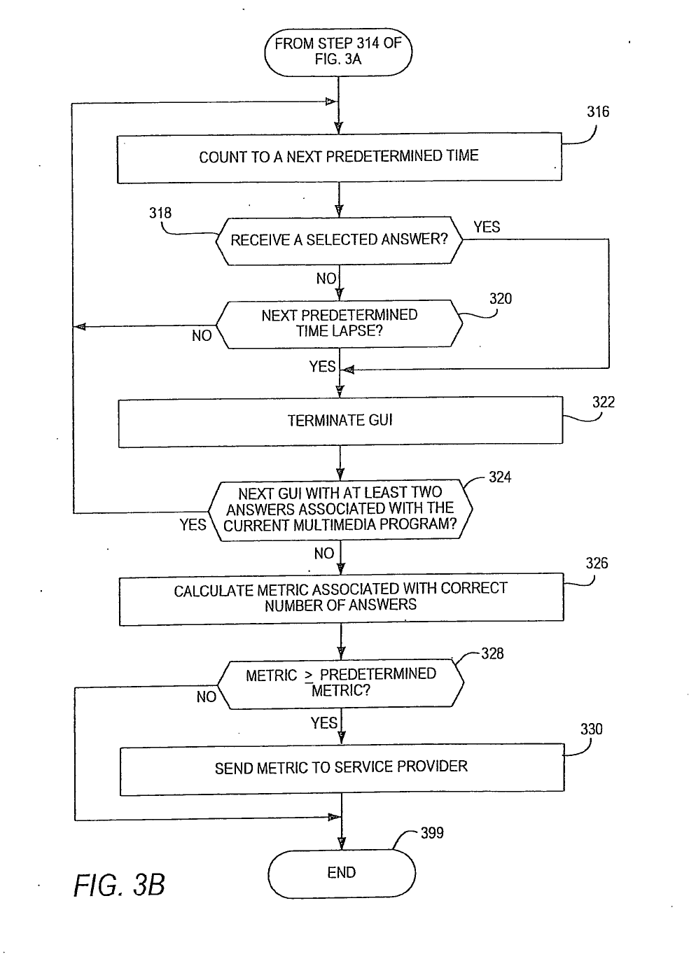

At step 210, a determination is made whether the current time equals a predetermined time to activate the applet 134. In particular, the applets that are stored on each end-user communication device 140, 160 are executed prior to or contemporaneously with the presentation of the program to enable the viewer participate with the content being presented to the viewer. Preferably, the applets are activated prior to presentation of the program so that a reminder message can be displayed on the viewer's communication devices 140, 160, as illustratively shown with respect to FIG. 4. Alternatively, the applets 134 can be activated on the viewer's communication devices 140, 160 at the beginning of the program presentation.

If at step 210 the current time does not equal the predetermined time to activate the applets 134, then the method 200 proceeds back to step 208 where the current time is again determined, until at step 210, the current time is equal to the predetermined time to activate the applets 134. The method 200 then proceeds to step 212.

At step 212, the applet distribution module 720 sends a signal to activate and synchronize the applet on the viewer's communication device 140, 160 with the service provider 130. If the user registered using a cellular device 140, the activation signal is transmitted over the wireless network 122 by the wireless carrier 120. Alternatively, where the user registered using a computer device over the internet, the activation signal is provided by the Internet content provider over the distribution network 150.

Once the applet 134 is activated, the method 200 proceeds to step 299 where method 200 ends, and the applet 134 on each viewer communication device 140, 160 operates in accordance with method 300 as described below with respect to FIGS. 3A and 3B.

Referring now to FIGS. 3A and 3B, a method 300 of executing the applet 134 and interacting with a pre-recorded multimedia program selected by a viewer having a communication device 140, 160 is illustratively shown. The method 300 begins at step 301, where the applet 134 has been received and is stored in the memory 144 of the viewer communication device 140,160 in accordance with the method 200 of FIG. 2. It is noted that the applets 134 operate as application programs in conjunction with the conventional circuitry (e.g., microcontroller/processor) and operating system of the cellular device 140 or computer device 160. For example, a cellular device 140 typically includes a thin client such as BREW (Binary Runtime Environment for Wireless) 146, which is stored in the memory 144 as a permanent application program interface (API). BREW or a similar API 144 enables end users to shop for, purchase, download, and install software on their cellular phone 140 via the wireless carrier's network 122.

At step 302, the viewer's communication device 140, 160 receives a time code signal from the service provider 130 to activate the applet 134. For cellular devices 140, the activation signal is received via the wireless communications network 122 from the wireless carrier 120. Alternatively, for computer devices 160 such as laptops and the like, the activation signal is illustratively received from a packetized network, such as the Internet 150.

At step 304, the applet is executed on the viewer's communication device 140, 160. The applet 134 acquires the current time from the host device, i.e., the cellular device 140 or the computer device 160, and sets an internal timer 136 of the applet to zero. The execution of the applet occurs at a predetermined time on the viewer's communication device 140,160 preferably prior to the scheduled multimedia program being displayed on the viewer's display device. Alternately, the execution of the applet can occur while the multimedia program 106 is being displayed on the viewer display device.

At step 306 the applet counts time and proceeds to step 308 where a determination is made whether a current time equals a first predetermined time. If at step 308 the current time is not equal to the first predetermined time the method proceeds to step 306, where the timer 136 of the applet 134 continues to count time until, at step 308, the current time is equal to a first predetermined time. The method 300 then proceeds to step 310.

At step 310, the applet generates an optional graphical user interface which presents a reminder message to the viewer. In particular, a reminder message can be displayed on the viewer's communication device 140,160 at a predetermined time prior to the selected multimedia programming being broadcasted or presented to the viewer on their television or computer device 160. In this manner, the viewer can receive a notification message that an opportunity to interact with multimedia programming 106 will be occurring at a scheduled time slot for that day.

Referring to FIG. 4, an illustrative cellular telephone 140 is shown having a display panel 142 with a reminder message 402 being presented to the viewer. The reminder message 402 illustratively shows the name 404 of the multimedia program, such as “The Shopping Spree”, which is being broadcasted at a specific time 406 (e.g., 9:00 p.m.) on that day. The reminder message 402 can be programmed to appear on the display panel 142 any time prior to the actual broadcast of the multimedia program, such as an hour, fifteen minutes, five minutes, among other times prior to the program being presented to the viewer. Further, the reminder message 402 is displayed for a predetermined duration, such as ten seconds, although such time is not considered limiting. The reminder message will terminate after such duration and the display panel 142 of the communications device 140, 160 will resume presenting the content that was previously being shown thereon or a blank screen.

The reminder message is programmed to terminate in the event that the user desires to make a phone call or receive a phone call or use the cellular device in any other manner so as the reminder message will not interfere with the normal operation of the cellular telephone 140 or computer device 106. Preferably the reminder message 402 will be generated repeatedly at predetermined intervals prior to the actual broadcasting of the multimedia program 106.

Referring to FIG. 3A, the timer 136 of the applet 134 continues to count time. At step 312, a determination is made whether the current time equals a second predetermined time. If at step 312 the current time does not equal the second predetermined time, then the method 300 proceeds to step 306, where the timer 136 continues to count time until at step 312, the current time equals the second predetermined time.

At a time prior to the current time equaling the second predetermined time, the content provider 102 begins and continues to send the multimedia program 106 to the registered viewers. At the second predetermined time, a question with a choice of corresponding answers is displayed on the viewer's television or computer device 106. The method then proceeds to step 314.

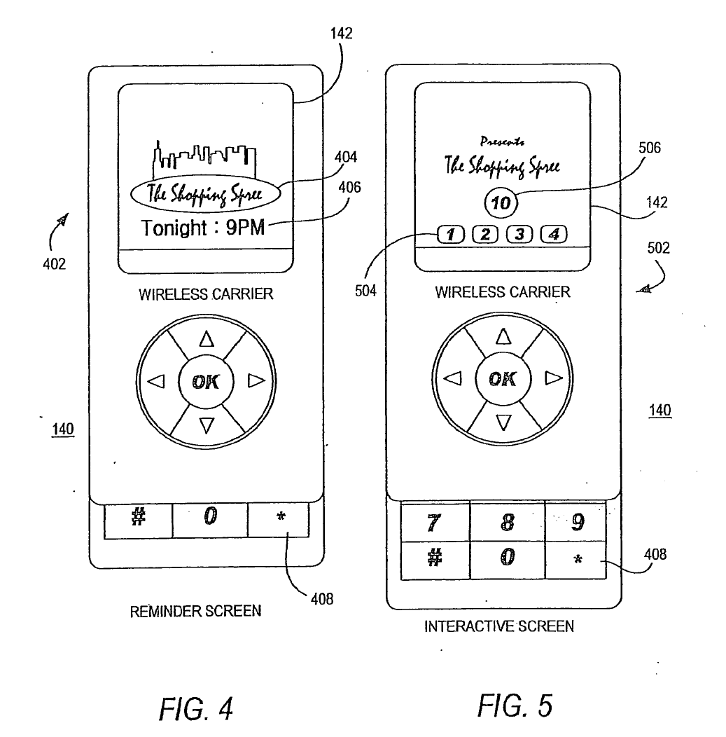

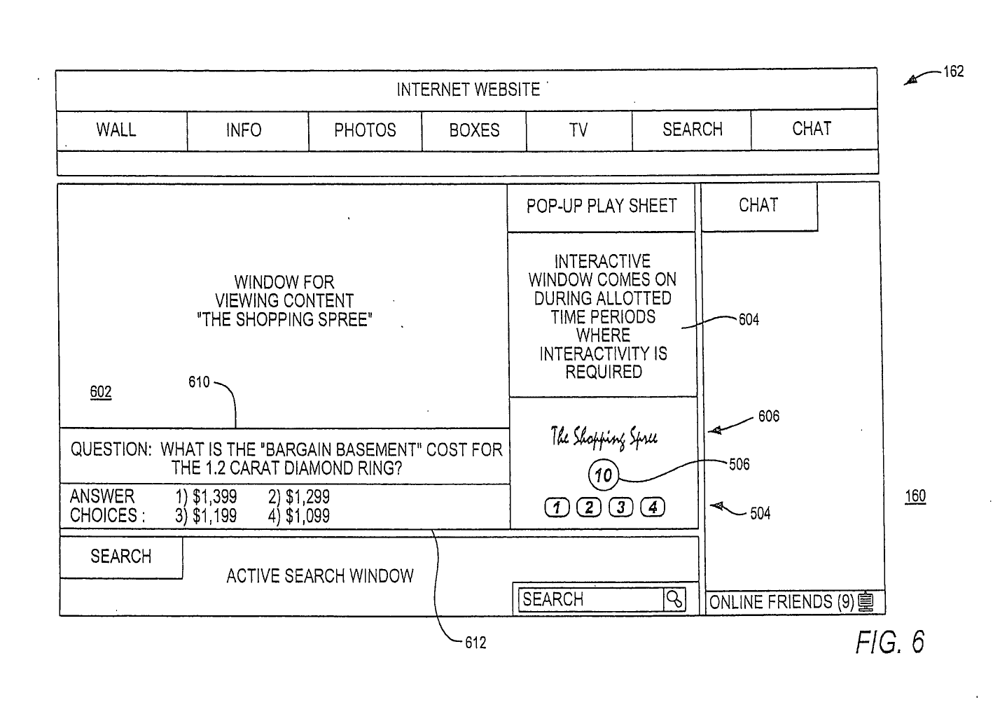

At step 314, the communications device 140, 160 displays a GUI (502 of FIG. 5 or 606 of FIG. 6) with at least two answer choices to the question while the multimedia program being broadcasted to the viewer. Accordingly, the applet is synchronized with the multimedia program via the time stamps and timer 136, and generates the GUI at the second predetermined time so that the viewer can view the multimedia content, the question and the choice of answers contemporaneously. The viewer can respond to the question by pressing an appropriate key on the keypad to select one of the answers.

Referring to FIG. 5, an illustrative cellular telephone 140 is shown with a GUI 502 displayed in the display panel 142. The GUI 502 includes four illustrative selectable choices 504 (e.g., numbers 1-4) from which the viewer can select by depressing the corresponding numbered key on the keypad 408 of the device 140, and a timer 506 which counts down the time such that the viewer must select one of the four answers 504 within the allotted time provided by the timer 506. Accordingly, the illustrative GUI 502 of FIG. 5 enables the viewer to interact in real-time using their cellular telephone 140 while watching the multimedia program 106, on, for example, their television set 160. In this embodiment, the viewer is using two communication devices to participate with the multimedia content, which gives the viewer the freedom to watch a program from their home or any other location. Thus, the television set is used for viewing the content, while the mobile cellular device 140 is used for interacting in real time with the multimedia program 106 being presented on the television.

Referring to FIG. 6, in an alternative embodiment, presentation of and interaction with the multimedia program 106 is provided on a single communications device 160. FIG. 6 illustrates a display panel 162 of a computer device 160 having, for example, a plurality of windows or pop-up screens, in which a first window 602 is designated to display the video multimedia program scheduled to be or currently being shown, and a second window 604 designated for display of the GUI 606, which is generated by the applet at one or more specified times. One or more areas of the display screen, website page or first window 602 can be designated to present a question and a plurality of answers to choose from, as illustratively shown by areas 610 and 612. The questions and answer choices can be presented as a banner or be included in the original recording of the program.

As described above with respect to the cellular device 140, the GUI 606 can similarly provide a reminder message, such as illustratively shown in FIG. 4 in the second window 604. Alternatively, the GUI 606 can display a graphic with a selection of choices 504 as illustratively shown in FIG. 5, which includes a plurality of selectable answers 504 and a timer 506 that is set to a predetermined time which counts down to zero. The viewer must select one of the answers 504 prior to the timer 506 counting down to zero in order to possibly answer the question correctly.

As shown in FIG. 6, the communications display device 160 presents video content of the multimedia program in the first window 602, a question in window 610, and a plurality of possible answers in window 612. The contents of windows 602, 610 and 612 are all provided by the content provider 102. The GUI 606 is provided in window 604 by the applet 134, and is synchronized to appear only when the questions and answers are being presented by the content provider 102, for example in windows 610 and 612.

Referring to FIG. 3B along with FIG. 6, at step 316 the GUI 606 is displayed on the communications device 140, 160 with the selection of answers 504, and the timer 506 counting to a next predetermined time. The GUI 606 will contemporaneously appear only at a time when the content provider 102 is streaming the multimedia program 106 with the question and choice of answers associated with the program, as illustratively shown in FIG. 6.

Specifically, at the scheduled time slot during the day, the content provider begins to broadcast or otherwise transmit the multimedia program to the registered viewers as described above. At the second predetermined time period (step 312) during the course of the program, a question with a choice of answers will be presented on the display device as well. At step 314, the applet GUI 606 is generated and presented on the display device 160. The method 300 then proceeds to step 316.

At step 316, the timer 506 counts down and if the viewer does not select a corresponding answer 504 to the question 610 appearing GUI 502, the method 300 proceeds to step 320, where if the next predetermined time has not lapsed (i.e., the timer 506 has counted down to zero), the method 300 proceeds back to step 316 and the timer 506 continues to count to the next predetermined time until at step 318, either the viewer has provided an answer by depressing one of the keys on the communication device or, at step 320, the predetermined time has lapsed. The method 300 then proceeds to step 322 where the GUI 606, as well as the question 610 and answer choices 612 provided by the content provider 102, are no longer presented on the display panel 142. The method 300 then proceeds to step 324.

As noted above, preferably more that one question and corresponding answers will be presented to the viewer to further increase viewer participation and viewership during the course of the program. Accordingly, for each question and answer set presented to the viewer, the applet 134 will generate a new GUI 502, 606 to enable the viewer to interact contemporaneously with the program. That is, as the multimedia program 106 progresses on the viewer's display device 160, the interactive applet can present multiple GUIs at different intervals to allow the viewer to participate with the programming during the course of the show.

At step 324, if a next question and corresponding answer choices is presented to the viewer and a next GUI 502, 606 that is associated with the question is concurrently generated by the applet 134, then the method 300 proceeds to step 316, where steps 316 through 322 are repeated. If at step 324, there are no more program questions, and accordingly, no more GUIs 502, 606 to be generated by the applet 134 and displayed on the viewer's communication device 140, 160 and, then the method 300 proceeds to step 326. Once the last GUI 502, 606 is presented and the user has responded with a selected answer or the GUI has timed out and terminated, at step 326 the applet 134 calculates a metric associated with the correct number of answer responses.

In one embodiment, the metric is a value corresponding to the correct number of response answers, i.e., a raw score of correct answers. Alternatively, the metric can be a percentage of the number of answers that the user correctly responded to during the course of the program.

At step 328 if the metric is greater or equal to a predetermined metric, the method 300 proceeds to step 330 where the metric value is sent to the service provider 134. The responses and aggregated scores are sent to the service provider 130 over the wireless communications network 122 by text messaging if the interactive viewer device is a cellular telephone 140 or via the packetized network 150 if the interactive viewer device is a computer device 160. Indicia of the winning participants can be stored as records or files 738 in the database 730 for future reference and selection of prizes, promotions and the like. The method 300 then proceeds to step 399. At step 399, the applet 134 for the previously viewed program 160 is terminated and erased from the memory of the communication device, 140,160, and the method 300 ends. If at step 328 the metric is not greater than the predetermined metric, then the method 300 proceeds directly to step 399, where the applet 134 is erased from the memory of the communication device 140,160 and the method 300 ends.

By illustration, assume during the course of the “shopping Spree” multimedia program 106 being presented on the viewer device 160 there are illustratively ten GUIs 502 that appear on the viewer's cellular device 140 at various predetermined times concurrent with questions from the content provider 102. Further, the applet is programmed such that a response signal is sent to the service provider 130 if the predetermined metric is at least fifty percent. If the viewer has responded correctly to at least five of the ten questions, then the fifty percent value or some other indicator associated with a winning value is sent to the service provider 130. The service provider 130 can use the metric to determine an overall winner from amongst all the participating viewers, and subsequently send promotional discounts or other awards or incentives to the winning viewers by email, and the like.

The present invention includes a Time-Stamped Digital Module or applet that is a digital protocol which enables the real-time interaction via a mobile and internet enabled devices. This digital protocol allows for an interactive viewer/participant experience where there is a consolidation of multiple-platforms, thereby combining traditional and new media platforms (i.e., television and Internet content providers) for large-scale viewership in a manner that allows participating viewers to interact with the multimedia programming simultaneously in a real-time manner. The present invention includes an applet that transforms viewership from a passive state to a more involved interactive state in real-time.

The applet includes a timer that can be synchronized in time with a server providing specific program content with digital time-stamps being transmitted or “aired” via the Internet (designated websites and/or social networking sites) and/or Television broadcasts. The time synchronization enables this interactive viewer type programming structure on multiple platforms simultaneously. For example, the television serves as the viewing medium, the Internet (website or social network) serve as both the viewing and Interactive mediums, and telephony mobile device and/or wireless-enabled device/platform serve as interactive mediums.

The applet provides the viewer with the opportunity to interact at appropriate times with the program content, which is synchronized with a common time-stamp that is coordinated via a server-based network of the content provider. This applet-based approach carries the digital time-stamp, which triggers the applet to automatically generate GUIs on the end-user communication devices at predetermined times.

The present application is compatible with all the existing platforms (BREW, Android, etc), as well as various phone families (i.e. Motorola, Nokia, RIM, etc). This application avoids SMS & WAP due to the latency involved. The present invention overcomes the technological deficiencies of the latency issues inherent in text messaging. Currently, there's no interactive medium existing for the mobile device to interact with the TV or Internet content in real-time. The latency issues make it difficult to use a basic text approach to achieve instantaneous interactivity, which is more desirable for enjoyment and interaction by the user. Accordingly, the applet of the present invention enables the mobile user to interact and be involved in the program in real time, as opposed to being affected by the latency effects that would occur if he/she had to send a text message at each interactive point.

While the foregoing is directed to embodiments of the present invention, other and further embodiments of the invention may be devised without departing from the basic scope thereof, and the scope thereof is determined by the claims that follow.

We claim:

1. A method for providing real-time interaction with a prerecorded multimedia program being presented to a viewer having an interactive end-user communications device, comprising:
providing an applet to the interactive end-user communications device, said applet including a timer and at least one interactive graphical user interface (GUI);
synchronizing activation of the applet with the multimedia program while being presented to the viewer, said applet programmed to generate, at a first predetermined time, a first interactive graphical user interface (GUI) on the end-user communications device, said first GUI displaying at least two values associated with the multimedia program for real-time selection by the viewer; and
receiving a response signal from the end-user communications device when at least a predetermined metric associated with correct selections of the at least two values by the viewer is satisfied.

2. The method of claim 1, wherein the step of providing an applet to the interactive end-user communications device comprises receiving a request from the end-user communications device to participate in an interactive session associated with the multimedia program from a content provider.

3. The method of claim 2, further comprising the step of programming the applet with time stamp codes, said time stamp codes corresponding to time stamp codes of the prerecorded multimedia program.

4. The method of claim 3, wherein the programming the applet with time stamp codes includes providing time stamp codes associated with at least one question and a corresponding set of answers for each question.

5. The method of claim 3, further comprising determining a specific applet to be provided based on the type of end-user communications device being used to send the request.

6. The method of claim 4, further comprising sending the applet to a mobile cellular telephone device over a wireless communications network.

7. The method of claim 4, further comprising sending the applet to a computer device over a packetized communication network.

8. The method of claim 2, wherein the step of synchronizing the applet comprises sending, from the service provider, a signal to activate the applet and initiate the timer.

9. The method of claim 7, wherein prior to receiving a response signal the method further comprises:
displaying the first GUI on the end-user communications device when the timer counts to the first predetermined time while the multimedia program is being sent to the viewer;
counting to a second predetermined time in response to a question being presented to the viewer along with said multimedia program;
identifying correct selections by the viewer of one of the at least two values displayed on the first GUI prior to the second predetermined time lapsing.

10. The method of claim 9, further comprising:
aggregating the correct selections by the viewer; and
sending the response signal with a value indicating the predetermined metric associated with correct selections by the viewer.

11. The method of claim 10, further comprising deleting the applet from the end-user communications device after the selected multimedia program sent to a viewer is completed.

12. The method of claim 1 further comprising sending a signal to activate the applet to display a program reminder message on the end-user communications device at a third predetermined time prior to said first GUI being displayed.

13. The method of claim 9, further comprising terminating the first GUI after one of the second predetermined time has lapsed or the user has made a selection of one of the at least two values.

14. The method of claim 10, wherein prior to the aggregating step, the method further comprises:
counting to a fourth predetermined time while the multimedia program is being sent to the viewer;
displaying, on the end-user communications device, a second GUI having at least two values for real-time selection by the viewer when the fourth predetermined time lapses;
counting to a fifth predetermined time in response to a question being presented with said multimedia program; and
identifying correct selections by the viewer of one of the at least two values displayed on the second GUI prior to the fifth predetermined time lapsing.

15. A system for providing real-time interaction with a multimedia program being presented to a viewer having an interactive end-user communications device, the system comprising:
a memory storing a plurality of applets specific to different types of end-user communications devices; each applet including a timer and at least one interactive graphical user interface (GUI);
at least one processor coupled to the memory; and
an applet distribution program stored in the memory and executable by the processor, the applet distribution program operable to:
provide an applet to the interactive end-user communications device, said applet including a timer and at least one interactive graphical user interface (GUI);
synchronize activation of the applet with the multimedia program while being presented to the viewer, said applet being programmed to generate, at a first predetermined time, a first interactive graphical user interface (GUI) displayed on the end-user communications device, said first GUI displaying at least two values associated with the multimedia program for real-time selection by the viewer; and
receive a response signal from the end-user communications device when at least a predetermined metric associated with correct selections of the at least two values by the viewer is satisfied.

16. The system of claim 15, wherein the applets include time stamp coding synchronized with the multimedia program.

17. The system of claim 15, wherein end-user communications device is a cellular device.

18. The system of claim 15, wherein multimedia program is selected from the group comprising prerecorded television programs, game programs, shopping programs movies, sporting events, and an interne provided program.

19. The system of claim 15, wherein the first interactive graphical user interface (GUI) displayed on the end-user communications device includes a reminder message.

20. The system of claim 14, wherein the first interactive graphical user interface (GUI) displayed on the end-user communications device includes multiple choice questions.
